(19) United States
(12) Patent Application Publication
(10) Pub. No.: US 2012/0116978 A1
(43) Pub. Date: May 10, 2012

(54) METHOD OF AND SYSTEM FOR SECURELY PROCESSING A TRANSACTION

(75) Inventors: Dirk Marinus Bruynse, Johannesburg (ZA); Schalk Johann Bezuidenhoudt, Northcliff (ZA)

(73) Assignee: MTN Mobile Money SA (Pty) Ltd, Fairlands (ZA)

(21) Appl. No.: 13/141,951

(22) PCT Filed: Dec. 18, 2009
(86) PCT No.: PCT/IB09/55838

§ 371 Date: Jan. 25, 2012

(30) Foreign Application Priority Data
Dec. 23, 2008 (ZA) 2008/10835

(51) Int. Cl. G06Q 30/06; H04L 9/32

(52) U.S. Cl. 705/72; 705/78

(57) ABSTRACT

A method of securely processing a transaction includes storing a plurality of encrypted financial transaction instrument identifiers in a memory wherein there is no decryption key for these stored in the memory and further wherein the encrypted financial transaction instrument identifiers are each associated with a mobile communications device. Receiving at a server a request to process a transaction, the request including an identification of a mobile communications device. Retrieving from the memory the encrypted financial transaction instrument identifier associated with the mobile communications device identified in the request. Transmitting the retrieved encrypted financial transaction instrument identifier to the mobile communications device. Receiving from the mobile communications device transaction data and using the received transaction data to effect a financial transaction.

### BACKGROUND OF THE INVENTION

THIS invention relates to a method of and system for securely processing a transaction, particularly using a mobile communications device.

A number of methods of processing transactions using mobile communications device are known. However, none of these offer a secure solution that is easy to use and effective.

It is an object of the invention to provide an improved method and system of securely processing a transaction.

### SUMMARY OF THE INVENTION

According to a first aspect of the invention there is a method of securely processing a transaction, the method including:
storing a plurality of encrypted financial transaction instrument identifiers in a memory wherein there is no decryption key for these stored in the memory and further wherein the encrypted financial transaction instrument identifiers are each associated with a mobile communications device;
receiving at a server a request to process a transaction, the request including an identification of a mobile communications device;
retrieving from the memory the encrypted financial transaction instrument identifier associated with the mobile communications device identified in the request;
transmitting the retrieved encrypted financial transaction instrument identifier to the mobile communications device;
receiving from the mobile communications device transaction data and using the received transaction data to effect a financial transaction.

The transaction data received from the mobile communications device may include a decryption key to decrypt a stored encrypted financial transaction instrument identifier associated with the mobile communications device.

Alternatively or in addition, the transaction data received from the mobile communications device includes a financial transaction instrument identifier to be used to effect the financial transaction.

Preferably the method includes the receiving of a PIN from the mobile communications device to authorise a financial transaction.

The PIN may be received via a different communication channel to the transaction data received from the mobile communications device.

The transaction data received from the mobile communications device may include one or more of:
third party identification data that identifies a third party to whom an amount is to be paid; and
the amount to be paid to the third party.

The method may further comprise using the received transaction data from the mobile communications device to create a transaction data packet to be transmitted to a financial system that uses the transaction data packet to effect the financial transaction.

In one example, the transaction data packet is structured in the same format as a card present data packet so that the financial system can treat the financial transaction as a card present transaction.

According to a second aspect of the invention there is a system for securely processing a transaction, the system including:
a memory storing a plurality of encrypted financial transaction instrument identifiers wherein there is no decryption key for these stored in the memory and further wherein the encrypted financial transaction instrument identifiers are each associated with a mobile communications device;
a communications module to receive a request to process a transaction, the request including an identification of a mobile communications device;
a retrieving module to retrieve from the memory the encrypted financial transaction instrument identifier associated with the mobile communications device identified in the request and to pass this to the communications module for transmitting to the mobile communications device; and
a data formatting module in communication with the communications module to receive from the mobile communications device transaction data and to use the received transaction data to effect a financial transaction.

The communications module may further receive transaction data from the mobile communications device, which transaction data includes a decryption key to decrypt a stored encrypted financial transaction instrument identifier associated with the mobile communications device.

Alternatively or in addition, the communications module further receives transaction data from the mobile communications device, which transaction data includes a financial transaction instrument identifier to be used to effect the financial transaction.

Preferably, the communications module further receives a PIN from the mobile communications device to authorise a financial transaction.

The communications module may receive the PIN via a different communication channel to the transaction data received from the mobile communications device.

In one example, the transaction data received from the mobile communications device includes one or more of:
third party identification data that identifies a third party to whom an amount is to be paid; and
the amount to be paid to the third party.

The data formatting module may further use the received transaction data from the mobile communications device to create a transaction data packet to be transmitted to a financial system that uses the transaction data packet to effect the financial transaction.

Preferably, the data formatting module structures the transaction data packet in the same format as a card present data packet so that the financial system can treat the financial transaction as a card present transaction.

According to a third aspect of the invention there is a method of securely processing a transaction, the method including:
storing on a mobile communications device a key to decrypt an encrypted financial transaction instrument identifier;
receiving at the mobile communications device an encrypted financial transaction instrument identifier;
decrypting the encrypted financial transaction instrument identifier;
displaying to a user of the mobile communications device the financial transaction instrument identifier together with information relating to a financial transaction;
prompting the user to enter an authentication PIN;
encrypting the authentication PIN and transmitting this over a communications network to a server thereby to instruct the server to process the financial transaction identified to the user.

The key to decrypt the encrypted financial transaction instrument identifier may be the same key that is stored in a memory on the mobile communications device and used by the mobile communications device to authenticate communications over a mobile communications network.

In addition, the financial transaction instrument identifier and authentication PIN may be transmitted over different communications networks to the server.

According to a second aspect of the invention there is a system for securely processing a transaction, the system including:
a memory having stored on a mobile communications device a key to decrypt an encrypted financial transaction instrument identifier;
a receiving module to receive at the mobile communications device an encrypted financial transaction instrument identifier;
a decrypting module to decrypt the encrypted financial transaction instrument identifier;
a display to display to a user of the mobile communications device the financial transaction instrument identifier together with information relating to a financial transaction;
a data input module to receive from the user an authentication PIN; and
an encryption module to transmit the PIN over a communications network to a server thereby to instruct the server to process the financial transaction identified to the user.

### BRIEF DESCRIPTION OF THE DRAWINGS

FIG. 1 shows a schematic diagram of a system in accordance with an example embodiment;

FIG. 2 shows a block diagram of the server of FIG. 1 in greater detail;

FIG. 3 shows a flow diagram of a method in accordance with an example embodiment;

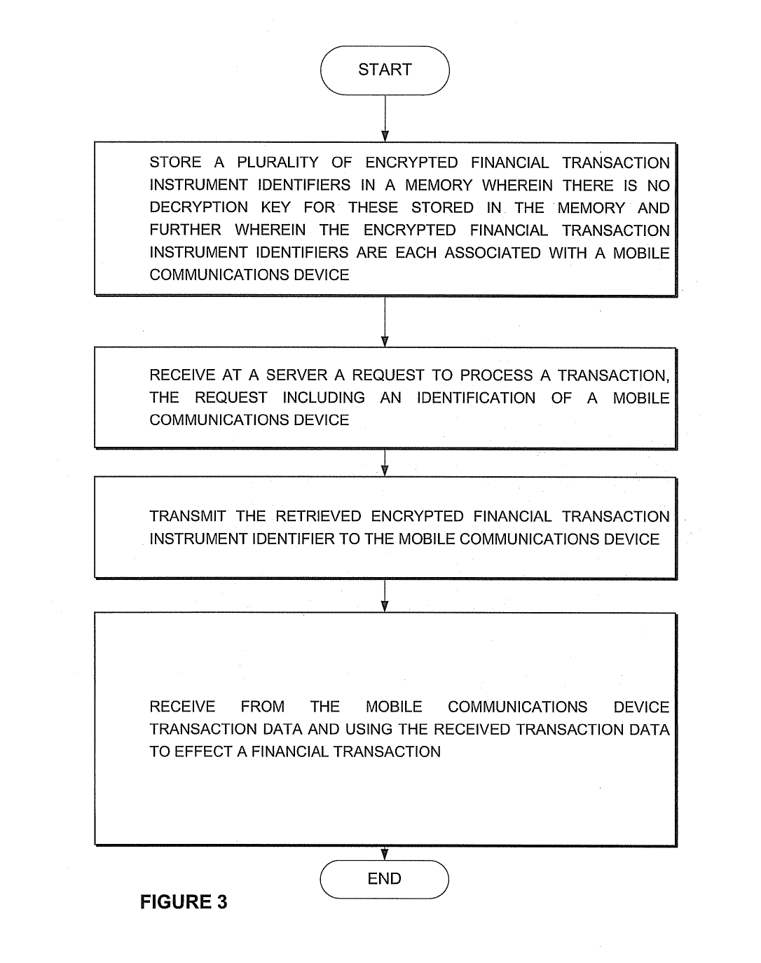

FIG. 4 shows a flow diagram of an example method of use for the present invention; and

FIG. 5 shows a block diagram of an exemplary mobile communications device.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

Referring to the accompanying Figures where a system and method in accordance with the invention are described, the system 10 includes a memory 12 in which a plurality of encrypted financial transaction instrument identifiers are stored.

What is important and what will be expanded upon in more detail later is that there is no decryption key for these stored encrypted financial transaction instrument identifiers in the memory 12 or in the associated server 14.

This means that neither the memory 12 nor the associated server 14 is able to decrypt these to extract the financial transaction instrument identifiers stored therein.

In addition, each encrypted financial transaction instrument identifier is uniquely associated with a mobile communications device 16 of a user 18.

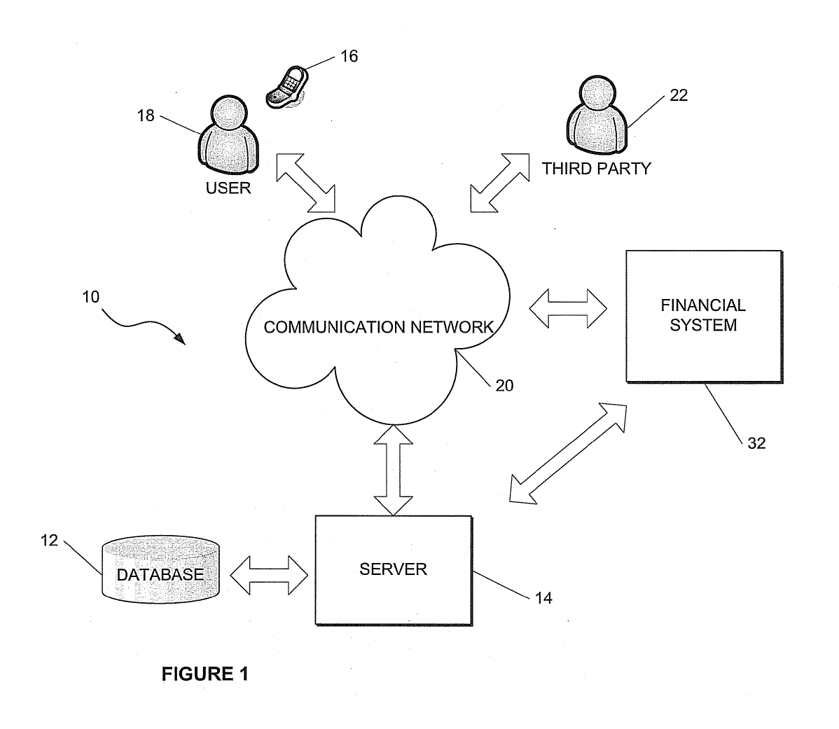

For convenience, only a single mobile communications devices 16 and user 18 are illustrated in FIG. 1, however in practice, there will be a plurality of mobile communications devices 16 each uniquely associated with a plurality of users 18.

One of the objectives of the present invention is to allow the user 18 to utilise the mobile communications device 16 for a financial transaction in a secure manner. In the methodology described below the financial transaction will be illustrated as a payment for goods or services but it will be appreciated that this is for exemplary purposes only and other types of financial transactions could equally be implemented using the system and methodology described herein.

In addition, the financial transaction instrument could be a credit or debit card, for example.

In order to obtain the financial transaction instrument identifiers and associate them with mobile communications devices, the user 18 will be required to register in order to use the system.

Prior to registering, the user must have a valid financial transaction instrument identifier such as a debit or credit card associated with a debit or credit card account, for example. Although the use of a single debit or credit card per user will be described below, the system is also able to accommodate a plurality of cards per user.

The user then accesses the server 14 via a communication channel to conduct the registration process.

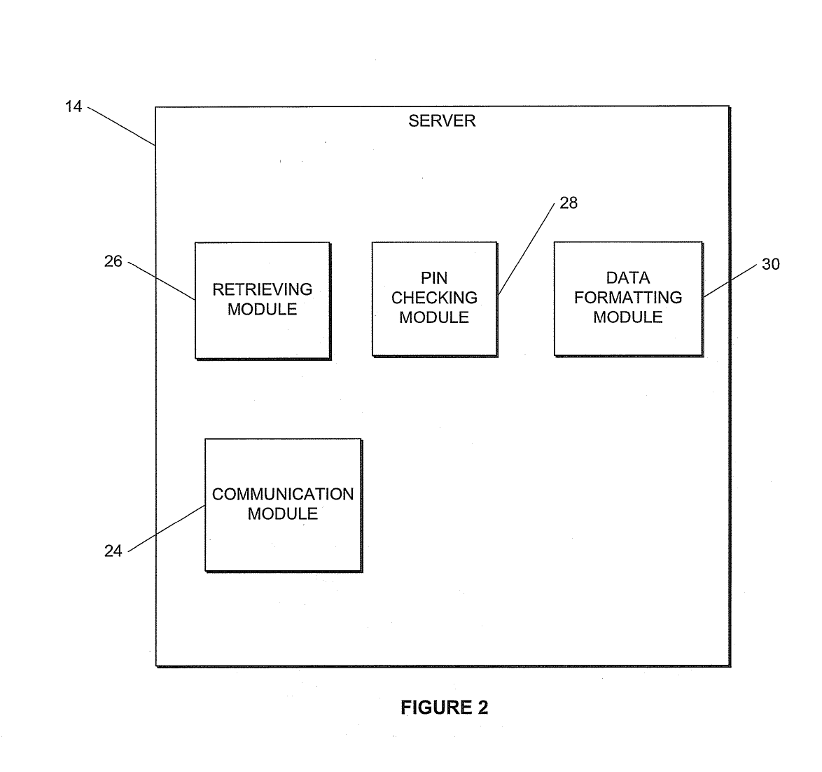

The server 14 illustrated in more detail in block diagram of FIG. 2 includes a communications module 24 for purposes of this and other communications that the server carries out as will be described below in more detail.

The communication channel used for the communication process could be the same communication channel 20 used to process transactions or could be another communications channel.

In the illustrated embodiment, the communication channel 20 includes a mobile communications network.

Where the user uses their mobile communications device 16 and communications channel 20, a number of protocols are available including dialing into an interactive voice response (IVR) server, engaging in an Unstructured Supplementary Service Data (USSD) processes, using a Wireless Application (WAP) or Wireless Internet Gateway (WIG) protocol to access the server 14, to name but a few examples.

Obviously, the user could use a different communications network and protocol to complete the registration process as mentioned above.

In any event, the server 14 or another server associated with the server 14 will include hardware and software to allow the user to access the server and complete the registration process.

For purposes of illustration, the registration process will be described as implemented by the server 14.

The server 14 receives the registration request and detects the identity of the mobile communications device such as the Mobile Station International Subscriber Directory Number (MSISDN) of the device, for example.

Where the user is not using the mobile communications device to register they will be prompted to enter the identity of the mobile communications device 16.

The server 14 validates that the identity of the mobile communications device is valid by checking the identity with the mobile communications network 20.

The user 18 is now prompted to enter personal identification details such as their identity number.

In addition, the user is prompted to enter financial transaction instrument details. In the illustrated embodiment of a credit card or a debit card, the user enters one or more of the card type, the card number, the expiry date of the card, and an account associated with the card

Where an account number is obtained from the user, the account may also be checked for a positive balance of available funds by the server 14.

Once the information is received at the server 14, the information is securely transmitted back to the user for confirmation on their mobile communications device 16 via the communications network 20.

The user confirms that the information is correct and then is additionally prompted from their mobile communications device 16 to enter one or more of a PIN number associated with the card and a check value displayed on the card know as the CV2, CVV or CVC value.

All of the financial transaction instrument information described above is then encrypted by the mobile communications device 16, transmitted via the communications network 20 to the server 14 and stored in the memory 12 associated with the personal information and mobile communications device 16.

As described above, the decryption key is not stored in the memory 12 or in any other memory associated with the server 14. Rather, the decryption key is stored only on a memory of the mobile communications device 16 with which the financial transaction instrument is associated. Typically, the memory is located in the SIM of the mobile communications device 16.

In one example embodiment this decryption key is the very same as the keys that are loaded to the SIM card at the point of manufacture in a secure environment to allow the SIM card to communicate securely over the communications network. The primary function of the keys is to prevent the illegal use of the mobile network infrastructure and the present invention piggy-backs on these keys. It will be appreciated that keys loaded after the manufacture process can be more easily compromised.

Thus a secure data structure or block is created that is uniquely accessible by the SIM of the mobile communications device 16 but is not stored in the mobile communications device 16. This secure data block containing the encrypted financial transaction instrument identifier is stored on the server 14 which is not able to access the block as it does not have access to the decryption key.

Once the user is registered they are able to conduct financial transactions using their mobile communications device 16 as the mechanism for conducting the transaction.

In the example below, the financial transaction will be described as the purchasing of a product or service where the mobile communications device 16 is then used to pay for the product or service. However, it will be appreciated that the financial transaction could be any other kind of financial transaction and is not limited to a payment transaction.

For purposes of illustration, the payment is made to a third party 22 that has an account of one kind or another with a financial institution. The third party 22 may or may not be connected on the communications network 20.

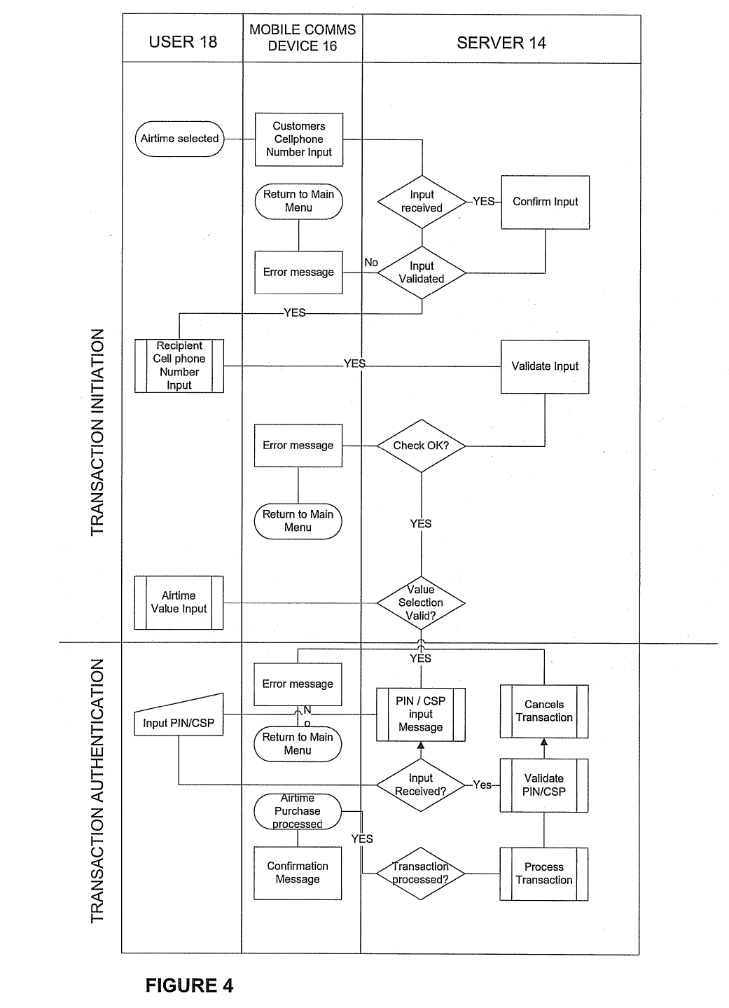

In any event, the user initiates the financial transaction by sending a transaction request message to server 14. The message could be sent using the mobile communications device 16 and the communications network 20 or the message could be sent to the server 14 using another communications channel. An embodiment of this initiation is shown in the first part of the process in FIG. 4.

If another communications channel is used the identification of the mobile communications device 16 will need to be sent through with the request. If the message is sent from the mobile communications device 16 the identity of the mobile communications device 16 will typically be able to be extracted from the message. This is normally done by detecting the Mobile Station International Subscriber Directory Number (MSISDN) of the device, for example.

In any event, the request is received at the server 14. This request acts as the trigger to set off the financial transaction process.

In response to a trigger, a retrieving module 26 of the server 14 retrieves from the memory 12 the encrypted financial transaction instrument identifier associated with the mobile communications device 16 from which the request was received or identified in the received request.

Using the communication module 24, the retrieved encrypted financial transaction instrument identifier is transmitted to the identified mobile communications device 16 via the communications network 20.

As described above, the mobile communications device 16 has stored thereon the key to decrypt the encrypted financial transaction instrument identifier received from the server 14.

In one example embodiment, at least some of the financial transaction instrument information is displayed to the user on the mobile communications device 16 for the user to confirm that the correct financial transaction instrument is to be used.

This is typically displayed to the user together with some information pertaining to the particular financial transaction so that the user can additionally confirm that this financial transaction instrument should be used for this financial transaction.

The user is then asked to enter their PIN to authenticate the transaction, which PIN is transmitted back to the server 14 as will be described below in more detail.

The PIN and other elements necessary to effect the transaction are then enciphered in a way that only the server 14 can access and then sent over the communication network 20 to server 14.

Some of the information obtained from the decrypted financial transaction instrument identifier is combined in mobile communications device 16 with the other transaction information which includes one or more of third party identification data that identifies a third party to whom an amount is to be paid and the amount to be paid to the third party.

Alternatively, the other information including details of the third party and amount to be paid could be transmitted to the server 14 separately although this would lessen the level of security to the transaction as separating the information from the authentication moment allows for transaction splicing and thus transaction manipulation.

The mobile communications device 16 thus builds up an encrypted transaction data packet and sends this to the server 14.

The encrypted transaction data packet is not a complete financial transaction but only includes components thereof and so the server 14 further constructs the transaction and sends it through to the bank for authentication. An example of what the data packet may include is as follows:

### First Data Set

### Senders MSISDN

Recipient MSIADN (recipient's identity in this example)

### Transaction Amount

### MSISDN Keys

### Second Data Set

### Senders MSISDN

### MSISDN Keys

### PIN

### CVV

In the example embodiment, the data transmitted back from the mobile device is in the encrypted data packet is sent to the server 14 via one communication channel whilst the user entered PIN is sent to the server 14 via another communications channel which is why the example above has two data sets.

It will be appreciated that this adds security to the transaction as the encrypted data packet cannot be used without the PIN and the PIN is useless with the encrypted data packet.

The two different channels could both be secure channels or one or more of the channels could be an unsecure channel.

In an illustrated embodiment the encrypted data packet was sent over a USSD channel which is an example of a relatively unsecure channel whilst the PIN was sent over a WIG channel which is a relatively secure channel.

This is because the WIG channel uses keys embedded in the memory of the communications device as described above to authenticate the communication. Another example of a secure channel is SAD which also uses authentication keys.

Thus, in one example embodiment, the authentication PIN is transmitted from the mobile communications device 16 over a secure channel in a manner that each transmittal is unique and the server 14 while validating the PIN also ensures transmittal uniqueness to ensure that the whole transaction block and or PIN has not be resubmitted. This is done to stop replay attacks and reuse of PINs

Once the server 14 receives the authentication PIN block from the mobile communications device 16, it checks that the PIN block is correct using PIN checking module 28. This PIN block will also be later sent to the financial institution for additional checking.

If the PIN is correct, the server 14 then decrypts the secured transaction data packet received.

The server 14 uses the identity of the mobile communications device to access the full financial transaction instrument identifier details which are still encrypted and not accessible to the server 14 without the secured transaction data block received from the mobile communication device.

The data block from the mobile device allows the server to extract the encrypted financial transaction instrument identifiers details for repackaging.

In one example embodiment, the keys received from the mobile communications device allow the server to decrypt the stored financial transaction instrument identifiers details associated with the MSISDN and create the financial transaction for onward transmission to the bank.

In an alternate embodiment, the financial transaction instrument identifier is transmitted back to the server by the mobile communications device for use by the server.

The server 14 thus uses the received data, together with the financial transaction instrument identifier to create a data packet to be transmitted to a financial system 32 that uses the data packet to effect the financial transaction.

In one example, the received data from the mobile communications device 16 is received in the correct format to be forwarded to the financial system 32.

In another example embodiment, the received data from the mobile communications device 16 is not received in the correct format to be forwarded to the financial system and is reformatted by a data formatting module 30 before being sent to the financial system 32.

In either case, the data packet is structured in the same format as a card present data packet so that the financial system can treat the financial transaction as a card present transaction.

It should be appreciated that “module” in the context of the specification includes an identifiable portion of code, computational or executable instructions, data, or computational object to achieve a particular function, operation, processing, or procedure. A module need not be implemented in software alone but a module may be implemented in software and/or firmware and/or hardware.

In one example illustrated in FIG. 4, the method and system are used to purchase airtime whereby an airtime purchase request is assembled by the user typically using their mobile communications device 16 and transmitted to the server 14 or an associated server—the first portion of FIG. 4.

The request is validated and the user is then prompted to enter the recipient's mobile communications device number. It will be appreciated that the user could enter here their own number and purchase airtime for themselves.

The received number that the user has input is checked to see it exists.

The whole transaction data and the encrypted financial transaction instrument identifier are then sent from server 14 via the communication network 20 to the identified mobile communications device 16 where the user is prompted to enter their PIN.

The communications device 16 then manipulates the transaction data and the encrypted financial transaction instrument identifier and PIN, as described above, and returns the secured transaction data block, the updated encrypted financial transaction instrument identifier and the secured PIN via the communication network 20 to the server 14.

The payment processed as described above, at which point the PIN is validated by the bank.

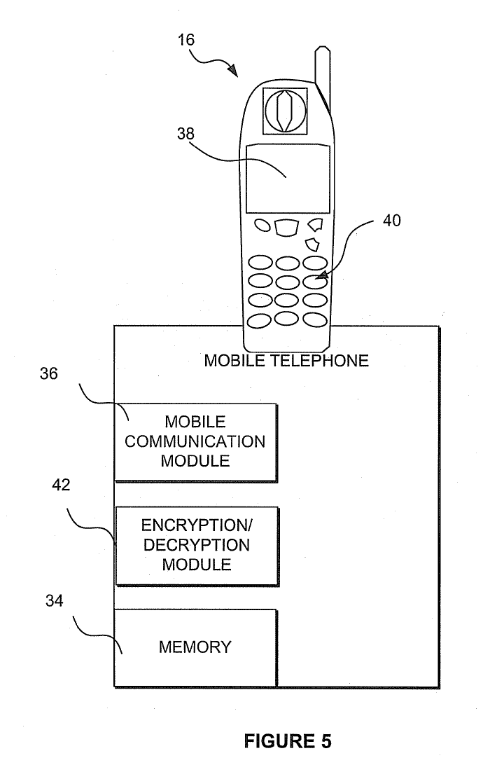

It will be appreciated that in order for the above to be implemented on the mobile communications device 16, the device will be modified as described below with reference to FIG. 5 which illustrates the device schematically. The modification will implemented as various modules on the mobile communications device 16. These can be implemented as identifiable portions of code, computational or executable instructions, data, or computational object to achieve a particular function, operation, processing, or procedure. A module need not be implemented in software alone but a module may be implemented in software and/or firmware and/or hardware.

In any event, the mobile communications device includes a memory 34 having stored thereon one or more keys to be used for various communication protocols and to decrypt an encrypted financial transaction instrument identifier. The memory 34 can be implemented on the mobile communications device itself or can form part of a SIM card, for example.

A receiving module typically incorporated into a mobile communications module 36 is used to receive at the mobile communications device an encrypted financial transaction instrument identifier and an encryption/decryption module 42 to decrypt the encrypted financial transaction instrument identifier.

A display 38 displays to a user of the mobile communications device the financial transaction instrument identifier together with information relating to a financial transaction.

A data input module 48, for example the keypad of the device is used to receive from the user an authentication PIN and the encryption/decryption module 42 re-encrypts at least the financial transaction instrument identifier and authentication PIN.

These are then transmitted over a communications network by the mobile communications module 36 to a server thereby to instruct the server to process the financial transaction identified to the user.

It will be appreciated that the various modules illustrated in FIG. 5 are further adapted to carry out the methodologies described above.

It will be appreciated that this is only one example of many applications for which the present method and system could be used.

The invention as hereinbefore described provides a new and secure way of processing a financial transaction.

The system and method allows users the ability to utilise their bank issued cards via their mobile communications device. The cards are registered and the information is securely stored and only available to the user of the communications device 16, negating the necessity for the customer to have the physical card at hand.

1. A method of securely processing a transaction, the method including:
storing a plurality of encrypted financial transaction instrument identifiers in a memory wherein there is no decryption key for these stored in the memory and further wherein the encrypted financial transaction instrument identifiers are each associated with a mobile communications device;
receiving at a server a request to process a transaction, the request including an identification of a mobile communications device;
retrieving from the memory the encrypted financial transaction instrument identifier associated with the mobile communications device identified in the request;
transmitting the retrieved encrypted financial transaction instrument identifier to the mobile communications device;
receiving from the mobile communications device transaction data and using the received transaction data to effect a financial transaction.

2. A method according to claim 1 wherein the transaction data received from the mobile communications device includes a decryption key to decrypt a stored encrypted financial transaction instrument identifier associated with the mobile communications device.

3. A method according to claim 1 wherein the transaction data received from the mobile communications device includes a financial transaction instrument identifier to be used to effect the financial transaction.

4. A method according to claim 1 further including the receiving of a PIN from the mobile communications device to authorise a financial transaction.

5. A method according to claim 4 wherein the PIN is received via a different communication channel to the transaction data received from the mobile communications device.

6. A method according to claim 1 wherein the transaction data received from the mobile communications device includes one or more of:
third party identification data that identifies a third party to whom an amount is to be paid; and
the amount to be paid to the third party.

7. A method according to claim 1 wherein the method further comprises using the received transaction data from the mobile communications device to create a transaction data packet to be transmitted to a financial system that uses the transaction data packet to effect the financial transaction.

8. A method according to claim 7 wherein the transaction data packet is structured in the same format as a card present data packet so that the financial system can treat the financial transaction as a card present transaction.

9. A system for processing a transaction, the system including:
a memory storing a plurality of encrypted financial transaction instrument identifiers wherein there is no decryption key for these stored in the memory and further wherein the encrypted financial transaction instrument identifiers are each associated with a mobile communications device;
a communications module to receive a request to process a transaction, the request including an identification of a mobile communications device;
a retrieving module to retrieve from the memory the encrypted financial transaction instrument identifier associated with the mobile communications device identified in the request and to pass this to the communications module for transmitting to the mobile communications device; and
a data formatting module in communication with the communications module to receive from the mobile communications device transaction data and to use the received transaction data to effect a financial transaction.

10. A system according to claim 9 wherein the communications module further receives transaction data from the mobile communications device, which transaction data includes a decryption key to decrypt a stored encrypted financial transaction instrument identifier associated with the mobile communications device.

11. A system according to claim 9 wherein the communications module further receives transaction data from the mobile communications device, which transaction data includes a financial transaction instrument identifier to be used to effect the financial transaction.

12. A system according to claim 9 wherein the communications module further receives a PIN from the mobile communications device to authorise a financial transaction.

13. A system according to claim 12 wherein the communications module receives the PIN via a different communication channel to the transaction data received from the mobile communications device.

14. A system according to claim 10 wherein the transaction data received from the mobile communications device includes one or more of:
third party identification data that identifies a third party to whom an amount is to be paid; and
the amount to be paid to the third party.

15. A system according to claim 10 wherein the data formatting module further uses the received transaction data from the mobile communications device to create a transaction data packet to be transmitted to a financial system that uses the transaction data packet to effect the financial transaction.

16. A system according to claim 15 wherein the data formatting module structures the transaction data packet in the same format as a card present data packet so that the financial system can treat the financial transaction as a card present transaction.

17. A method of securely processing a transaction, the method including:
storing on a mobile communications device a key to decrypt an encrypted financial transaction instrument identifier;
receiving at the mobile communications device an encrypted financial transaction instrument identifier;
decrypting the encrypted financial transaction instrument identifier;
displaying to a user of the mobile communications device the financial transaction instrument identifier together with information relating to a financial transaction;
prompting the user to enter an authentication PIN;
encrypting the authentication PIN and transmitting this over a communications network to a server thereby to instruct the server to process the financial transaction identified to the user.

18. A method according to claim 17 wherein the key to decrypt the encrypted financial transaction instrument identifier is the same key that is stored in a memory on the mobile communications device and used by the mobile communications device to authenticate communications over a mobile communications network.

19. A method according to claim 17 wherein the financial transaction instrument identifier and authentication PIN are transmitted over different communications networks to the server.

20. A mobile communications device including:
a memory having stored on a mobile communications device a key to decrypt an encrypted financial transaction instrument identifier;
a receiving module to receive at the mobile communications device an encrypted financial transaction instrument identifier;
a decrypting module to decrypt the encrypted financial transaction instrument identifier;
a display to display to a user of the mobile communications device the financial transaction instrument identifier together with information relating to a financial transaction;
a data input module to receive from the user an authentication PIN; and
an encryption module to transmit the PIN over a communications network to a server thereby to instruct the server to process the financial transaction identified to the user.
